(19) United States
(12) Patent Application Publication
(10) Pub. No.: US 2008/0044082 A1
(43) Pub. Date: Feb. 21, 2008

(54) Method and System for Automatic Determination of Colors as Well as a Corresponding Computer Program and a Corresponding Computer-Readable Storage Medium

(75) Inventor: J. Christian Muller, Friedrichsdorf (DE)

Correspondence Address: WORKMAN NYDEGGER, 60 EAST SOUTH TEMPLE, 1000 EAGLE GATE TOWER, SALT LAKE CITY, UT, 84111, US

(73) Assignees: SUSI AXANA-MULLER, FRIEDRICHSDORF (DE); J. CHRISTIAN MULLER, FRIEDRICHSDORF (DE)

(21) Appl. No.: 11/571,738

(22) PCT Filed: Jun. 29, 2005
(86) PCT No.: PCT/DE06/02978

§ 371 Date: Jan. 5, 2007

(30) Foreign Application Priority Data
Jul. 6, 2004 (DE) 10 2004 033 585.0

(51) Int. Cl. G06K 9/00

(52) U.S. Cl. 382/162

(57) ABSTRACT

The invention relates to a method and a system for automatic determination of colors, which can in particular be applied in online commerce. The invention makes it possible for a provider, for example, to indicate the correct color of merchandise, so that a customer can knowingly find, order and acquire the merchandise. To this end, it is proposed that the color to be determined is recorded together with at least one reference color. The recorded data is read. The recorded data of at least a portion of the reference color is compared with stored comparison values of the reference colors. The color to be determined is automatically determined by evaluating at least a portion of the recorded data of the color to be recorded and of at least a portion of the difference values determined in the comparison between read-in data and stored comparison values.

The invention relates to a method and a system for automatic determination of colors and a corresponding computer program and a corresponding computer-readable storage medium which, in particular, can be used in online commerce. The invention allows a provider to indicate, for example, the correct color of merchandise, so that a customer can knowingly find, order and acquire the merchandise. Application devices are, in particular, personal computers with a scanner or a digital camera, but also photo handies with adequate resolution or photo-PDAs, color fax machines or other telecommunication devices.

Traditionally, so-called color fans are used to determine color. These color fans include a number of colors, whereby the colors are arranged according to accepted color systems, such as for example Pantone or RAL color systems. A RAL classic color fan includes, for example, 192 to 210 colors. These color fans are placed next to the color to be determined, and the color of the sample or object is determined through comparison with the naked eye by associating with the sample or object the particular color code of the fan color that is closest to the color to be determined. However, this method has the disadvantage that the evaluation is very subjective, and that certain errors cannot be excluded, for example, due to artificial lighting or misinterpretation that may be caused in an extreme situations by color blindness.

Another conventional method for automatic color determination is the so-called photo spectrometric method, with a holographic diffraction grating which is used, for example, for evaluating the quality of paints, prints or the quality of color renditions of monitors and displays, respectively. With this method, the print or the screen rendition of defined colors is scanned with a reader and compared with reference data of different DIN, ISO or Fogra test charts. The quality is determined based on deviations. Although absolute spectral values of colors can be determined with this method, the method disadvantageously requires a detailed understanding of the process, substantial computing power, as well as prohibitively expensive and impractical hardware and software unsuitable for the average user.

It is therefore an object of the invention to provide a convenient and inexpensive method and a system for automatic determination of colors as well as a corresponding computer program and a corresponding computer-readable storage medium, which obviates the aforedescribed deficiencies and which makes it possible to automatically determine the correct absolute value of colors using available conventional means (such as PC, digital camera, Internet).

The object is solved with the invention by the features recited in the claims 1, 16, 20 to 26, 28 and 29. Advantageous embodiments of the invention are recited in the dependent claims.

It is a particular advantage of the method of the invention for automatic determination of colors that the correct color can be determined independent of color distortions that may occur with color importation or a digital photo, in that at least one color to be determined together with one or several reference colors, such as for example gray levels G1 to G16, red, yellow, blue, white and/or black, are recorded in computer-readable form, and that a computer program installed on a data processing device
reads the recorded data,
compares recorded data of at least a portion of the reference colors with stored comparison values of the reference colors,
determines the color(s) to be determined automatically by processing at least a portion of the recorded data of the color to be determined and of least a portion of the difference values determined in the comparison between read-in data and stored comparison values.

Advantageously, the color(s) to be determined and the reference color(s) are recorded by using a PC with a conventional digital camera or a scanner. Other potential applications are modern smart phones or PDAs with a high-resolution camera, color fax machines or other recording devices.

The colors to be determined are advantageously imported by using, for example, conventional visualization, graphic or CAD software.

A system for automatic determination of colors is advantageously configured so as to include
means for recording colors,
at least one data processing device,
means for data input and data output,
means for data storage,
at least one computer program installed on the data processing device,
   wherein the means for recording colors records at least one color to be determined together with one or several reference colors, for example gray levels G1 to G16, red, yellow, blue, white and/or black, in computer-readable form, wherein the computer program
reads the recorded data,
compares data of at least a portion of the reference colors with stored comparison values of the reference colors,
automatically determines the color(s) to be determined by evaluating at least a portion of the recorded data of the color to be determined and at least a portion of the difference values between the read data and the stored comparison values determined during the comparison, and
   wherein the system outputs at least the determined color(s) via a means for data output and/or provides the determined color(s) for recall on a means for data storage.

A computer program for automatic determination of colors enables a computer, after the computer program is loaded into the memory of the computer, to execute a method for automatic determination of colors, wherein
data recorded in computer-readable form of at least one color to be determined are read in together with one or several reference colors, such as for example gray levels G1 to G16, red, yellow, blue, white and/or black,
recorded data of at least a portion of the reference colors are compared with stored comparison values of the reference colors,
the color(s) to be determined is/are automatically determined by evaluating at least a portion of the recorded data of the color to be determined and of at least a portion of the difference values between the read in data and the stored data that were determined in the comparison.

For example, these computer programs can be provided for downloading in a data or communication network (for a fee or free of charge, freely accessible or password-protected). The computer programs provided in this manner can then be used with a process, in which a computer program according to claim 21 or 24 is downloaded from an electronic data network, for example from the Internet, to a data processing device connected to the data network.

To carry out automatic determination of colors, a computer-readable storage medium is advantageously employed on which a program is stored which enables a computer, after the program is loaded into the computer, to execute a method for automatic determination of colors, wherein
data recorded in computer-readable form of at least one color to be determined are read in together with one or several reference colors, such as for example gray levels G1 to G16, red, yellow, blue, white and/or black,
recorded the data of at least a portion of the reference colors are compared with stored comparison values of the reference colors,
the color(s) to be determined is/are automatically determined by evaluating at least a portion of the recorded data of the color to be determined and of at least a portion of the difference values between the read in data and the stored data that were determined in the comparison.

According to a preferred embodiment of the method of the invention, the computer program automatically finds the data of the reference colors and/or of the color(s) to be determined, for example by comparing patterns of colored areas within the recorded data, or identifies the colors based on the sequential order of their input as reference color and/or as the color to be determined. This has the particular advantage that the color is determined without user intervention.

It is frequently advantageous to determine the color with as few computer resources as possible. According to another advantageous embodiment of the inventive method, the recorded colors are visualized through means for data output, such as for example a monitor or display, and one or several reference colors and/or color(s) to be determined are defined via a means for data input, such as a computer mouse. With this approach, computing resources, which would otherwise be required for comparing patterns to determine reference color(s) and/or color(s) to be determined, are advantageously economized by defining colors via input means.

The automatic determination of color(s) to be determined may advantageously also include forming an average of recorded data of the color to be determined and/or of the reference color. Such approach works particularly well when the colors are provided by the means for data input, such as a computer mouse, wherein the computer program may evaluate a number of pixels surrounding the position defined by the mouse click. For example, 9×9=81 pixels have proven to be advantageous for uniform colors lacking a pattern. In this way, errors resulting from incorrectly colored pixels can be eliminated in the recording.

According to another advantageous embodiment of the inventive method, reference contrast values are read in addition to the reference colors.

The inventive method can be used in a particularly simple manner by providing the reference color(s) to be read and/or reference contrast values on a carrier element, for example a printed card, or as a file (e.g., as a PDF version of the printed card) with device-independent print information for calibrated printing systems. A user of the inventive method can then manufacture a carrier element with reference color(s) to be read in and/or with reference contrast values by printing the file with the device-independent print information. The use of calibrated printing systems to print the file ensures that the correct reference colors are also printed. For a quick evaluation of the recorded colors it is advantageous, if the reference colors and/or reference contrast values are arranged on the carrier element in a predetermined pattern. This can be achieved, for example, by arranging the reference colors, reference contrast values and the color(s) to be determined on the carrier element as concentric circular rings, by inputting into the computer program with a mouse click a marked location recorded on the carrier element, such as for example the center of the circle formed by the circular rings, wherein the computer program determines the data associated with the reference colors, reference contrast values and/or the color(s) to be determined based on the pattern defined on the carrier element and the position data.

According to another embodiment, the reference colors and/or the reference contrast values are arranged on the carrier element as circular sectors and the color(s) to be determined is/are arranged at a predetermined position, the center of the circle formed by the circular sectors is inputted into the computer program by a first mouse click and the position of the color(s) to be determined is inputted into the computer program by a second mouse click, wherein the computer program determines, based on the pattern and the position data defined on the carrier element, the data associated with the reference colors, reference contrast values and/or the color(s) to be determined.

According to another embodiment of the carrier element, an opening is arranged in the center of circularly arranged reference contrast values, through which the a color to be determined is visible, and the reference colors are arranged in a predetermined, a well-defined manner with respect to the reference contrast values. In this embodiment, the color(s) to be determined and the data required for determining the orientation of the carrier element are inputted in a similar manner by a mouse click in the center of the circularly arranged reference contrast values (definition of the position of the color(s) to be determined), and an additional mouse click at a second defined position, thereby indicating the orientation of the carrier element.

It has also proven to be advantageous to store the comparison values of the reference colors in one or several databases, wherein the databases provide color renditions according to at least one color system, such as for example RAL color systems, CIELAB color spaces, ICC or sRGB color space, Natural Color System (NCS), Pantone and/or Dumont color atlas. To ensure the most accurate determination and association of the color(s), at least one adequately large color database with references should also be used. Advantageously, the recorded data are read in by means for data input and these means for data input are connected by means for data transmission, such as for example the Internet, wireless communication networks or the like, to the data processing device on which the evaluation computer program is installed. This is particularly advantageous if, for example, customers at online auctions record the color to be determined together with a calibration chart by using a digital camera or a scanner, input the image data into a computer and transmit these data to a remote central server on which the software for evaluating the color data is installed, whereafter the color to be determined is transmitted from the central server, optionally for a fee, back to the customer. Color data can also be recorded with a photo handy and directly transmitted to the central server via MMS. One particular application of the method is, for example, tele-shopping. To allow the customer precise color determination, the provider of the merchandise shows the merchandise together with a calibration chart. The color data are recorded by the camera and transmitted via telecommunication to the customer's terminal (television set, computer monitor, or color display on a handy or PDA, and the like). The customer stores the representation, e.g., in a so-called screenshot, and transmits the data for evaluation to the evaluation computer program which may be installed on the customer's computer or on a remote central data processing device (server). This allows an exact automatic color determination independent of location of the communication partners (provider, customer).

In particular, the data can be transmitted via:
the Internet in general,
intranet works or limited networks,
local area networks (LAN),
wireless LAN (WLAN) via hotspots,
fax connections (color protocol),
ISDN direct dial,
analog modem direct dial,
cable and/or satellite television,
power cables with modulated data signal (power line),
analog/digital radio links,
GSM (=Global System for Mobile Communications) in a different frequency ranges,
GPRS (=General Packet Radio Service),
HSCSD (=High Speak Circuit Switched Data),
UMTS (=Universal Mobile Telecommunications System),
Bluetooth/IrDA (=Infrared Data Association),
ADSL (=Asymmetric Digital Subscriber Loop) or satellite DSL, or
mixed implementations and new developments of these transmission modes.

In another preferred embodiment of the inventive method, the data processing device may be connected by means for data exchange with at least one database and may link the determined color(s) with additional data and outputs and/or provides the determined color(s) with the additional data for recall. In particular, in Internet commerce dealing with clothes or fashion apparel, the additional data advantageously include information about comparable colors of other color catalogues and/or color proposals for combination with the determined color(s).

In online commerce, it is advantageous for representing (digital) images on the Internet, to automatically correct corruption of the digital color representations caused by the recording after comparison of at least a portion of the reference colors with stored comparison values of the reference colors, for example, by shadow or reflection computations. In this way, potential customers get the correct impression of the actual color layout of the samples or merchandise.

According to another method for automatic determination of colors, data presented in computer-readable form of a color represented in a first color system or color space are compared with color representations of at least a second color system or color space, and in order to determine the color of the first color system/color space, the color from the second color system/color space or from one of the second color systems/color spaces is determined, which according to a predeterminable distance definition provides the smallest distance valueΔE to the color of the first color system/color space, and/or that color from the second color system/color space or from one of the second color systems/color spaces is determined, which corresponds to a the color of the first color system/color space to be determined according to a predefinable allocation rule. This is particularly advantageous if colors are imported from visualization or graphic programs that use unknown or rarely used color representations. The color representations of the second or additional color systems advantageously exist internal to the computer in digital form. Alternatively, digital storage media with color databases can be used which are accessed when the process is executed. According to a preferred embodiment of the inventive method, the data of the color represented in computer-readable form in a first color system or color space are generated by a computer program, such as for example a graphic program, or are imported from computer programs or databases, instead of being scanned, or obtained from digital photos. The colors to be determined are advantageously imported, for example, from conventional visualization, graphic or CAD software. With the proposed inventive method, the respective color can be determined from a known or standard color system, which has the best match to the “unknown” color, by automatic distance computation, for example by interpolation, or by evaluation of association matrices or association tables. Advantageously, the allocation rule is stored in at least one allocation matrix and/or at least one allocation table, wherein the entries of the matrix and/or table allocate to each color of the first color system/color space a color of a second color system/color space. The distance definition uses a computation rule, which computes from the values of the color representations (color codes) in a first color system/color space a distance valueΔE to the colors in a second color system/color space.

It has also proven to be advantageous to introduce a distance threshold value. If the computation rule only provides distance valuesΔE which are greater than the distance special value, this is an indication that no comparable color exists in the second color system/color space. In this case, the system proposes several colors of the second color system/color space. The same proposal is also applied if two colors of the second color system/color space have the same distance to a color of the first color system/color space. In one process for using a method for automatic determination of colors, a carrier element, on which at least one reference color, such as for example gray levels G1 to G16, red, and yellow, blue, white and/or black is arranged, is provided by a provider of a method for automatic determination of colors, and a user of the method for automatic determination of colors records on the carrier element in computer-readable form at least one color to be determined together with one or several reference colors arranged on the carrier element, transmits the data recorded in computer-readable form to the provider, and the provider determines for a fee the color(s) to be determined by using a computer program installed on a data processing device, wherein
the computer program reads the transmitted data recorded in computer-readable form,
compares recorded data of at least a portion of the reference values with stored comparison values of the reference colors,
automatically determines the color(s) to be determined by evaluating at least a portion of the recorded data of the color to be determined and at least a portion of the difference values between the read in data and the stored comparison values determined in the comparison, and transmits the determined color(s) to the user and/or provides the determined color(s) for recall on a data store.

In a particularly advantageous embodiment, the transmission of data recorded in computer-readable form to the provider can be offered as an optional service in other computer programs, such as for example online shopping or auction systems. A customer of the online shopping or auction system can then transmit the recording of his articles (which were recorded together with the carrier element) to the provider of the service “color determination”, e.g., by uploading the digitized recording to a server, on which a computer program according to the invention for automatic color determination is installed. After the automatic color determination, the results can be provided to the user and/or can be automatically processed by the online shopping or auction system, for example, by adding the determined color automatically to the description of the article. Additional applications may be in the area of tele-shopping using digital television, where images can be stored, analyzed by using color comparison charts, and colors can be reliably determined and/or offered.

The proposed automatic color determination also contemplates the use of smart phones, photo handy or photo PDA with adequate camera resolution and transmission speed (e.g., UMTS). Color fax machines are another option for data input that can be further processed by a PC.

An exemplary embodiment of the invention will now be described with reference to the figures in the drawings. It is shown in:

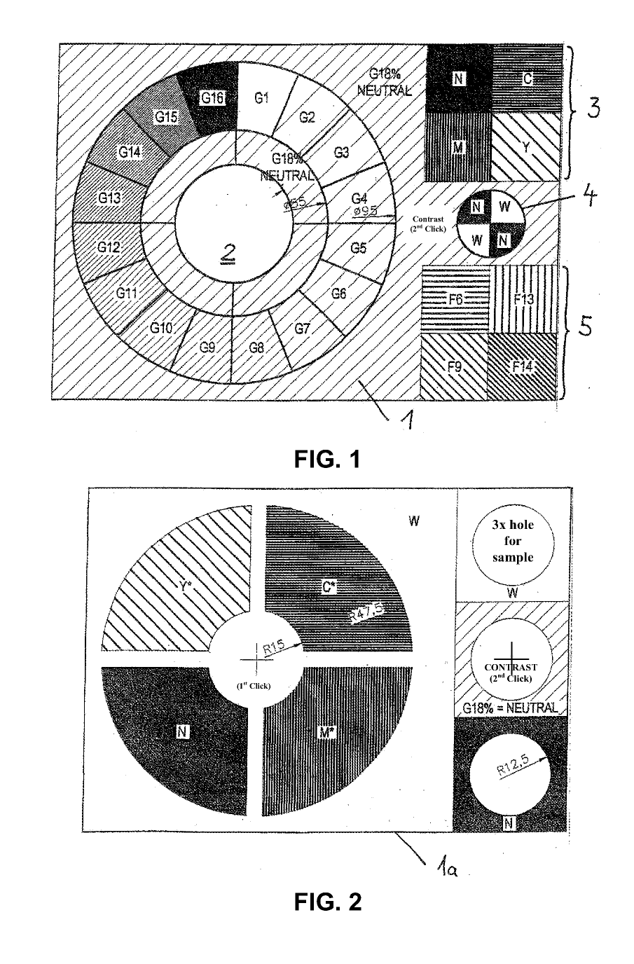

FIG. 1 a schematic diagram of a first calibration chart as an exemplary carrier element, “3C”-Card-1 (COLOR CALIBRATION CHART 1),

FIG. 2 a schematic diagram of a second calibration chart as an exemplary carrier element, “3C”-Card-2 (COLOR CALIBRATION CHART 2),

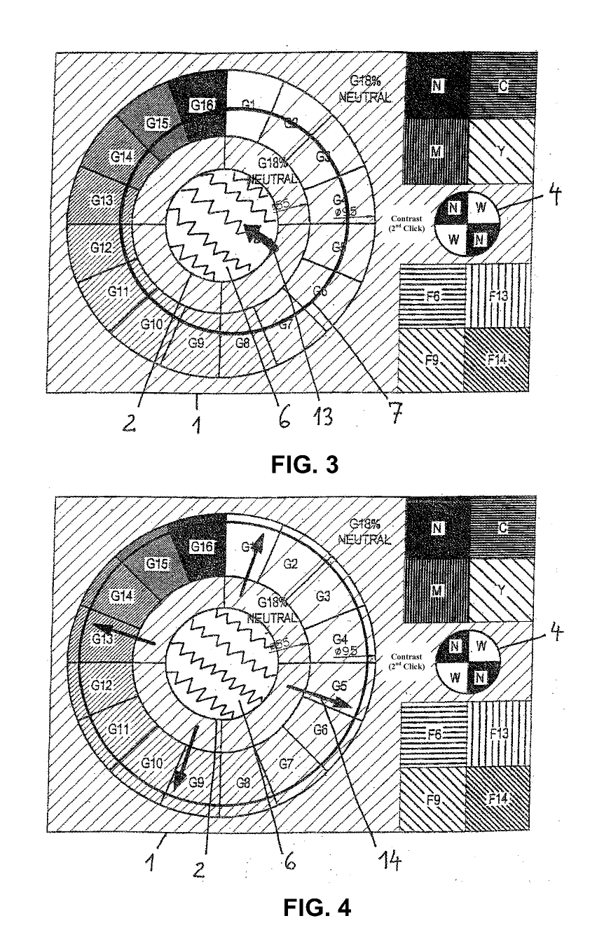

FIG. 3 visualization of the first step in an exemplary method for automatic determination of colors, wherein the first step is used to define the position of the reference colors,

FIG. 4 visualization of the second step in the exemplary method, wherein the second step is used to define the position of the color to be determined,

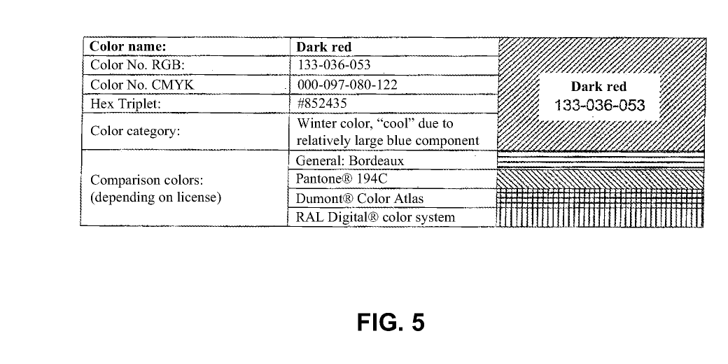

FIG. 5 illustration of an exemplary output of the color to be determined and additional data.

The invention will now be described in more detail with reference to an exemplary special case using a carrier element with 24 reference colors (see FIG. 1). It should be noted that the invention is not limited to the exemplary embodiment described below, but that the underpinnings for the computations and/or the reference colors can also be provided in a different manner. For example, the carrier element depicted in FIG. 2, representing a calibration chart 1a with five reference colors, can also be used.

In the following exemplary embodiment based on the calibration chart 1, which will be the term used hereinafter for the exemplary carrier element, depicted in FIG. 1, precisely defined print colors are used as reference colors: on the left side, there is shown a circle with 16 gray levels from pure white W to black N, inside (delineated with neutral gray) an opening 2 for determining the sample color, diameter 35 mm. On the right side are the colored squares 3 (20×20 mm) with the colors: Black N, cyan C, magenta M and yellow Y. (White and black are typically not considered colors, but to facilitate the following discussion, white and black will also be designated as colors in the context of this description). The calibration chart 1 also includes on the right margin a second circle 4 with a diameter of 20 mm with reference contrast values (pure white W and a black N). The lower color reference squares 5 are each provided with four user-specific color references (chlorophyll F14, azure F6, roseate F9 and pink skin color F13).

To determine the color of a sample or object 6, the user associates the calibration chart 1 with the sample or object 6 in such a way that the color to be determined is visible through the opening 2 in the center of the contrast circle (see FIGS. 3 and 4). The user subsequently records this arrangement of sample/object 6 and a calibration chart 1 with a digital camera or a scanner.

In successful experiments, recordings with a resolution of 1280×1024 pixels were made. The size of the calibration chart 1 was about one eights of the entire recording (about 320×256 pixels). The employed data format was JPEG with a color depth of 24 bits (=16.7 million colors). Alternatively, higher resolutions and other uncompressed formats, such as TIF, can also be used. Optimal results are achieved if the calibration chart 1 is recorded from the front and the calibration chart 1 is closely positioned on the sample/object 6, because otherwise the color to be determined is affected, for example, by shadows forming in the opening 2. If the angle at which the calibration chart 1 is recorded is too shallow, adverse effects can also occur. However, the exemplary computer program for automatic determination of the colors is configured to recognize these effects and can optionally generate a warning or error message.

The recordings with a digital camera can be made in daylight or by using a flash. Although the exposure and/or compression methods affect the reference colors and the reference contrast values as well as the color to be determined, these are compensated with the method of the invention by also evaluating the recorded reference colors.

After the sample/object space type 6 and the calibration chart 1 are recorded, they have to be uploaded in the exemplary embodiment to a server. The program then displays the recorded image on a display screen, as illustrated in FIG. 3. If the computer program did not automatically determine the reference colors and the colors to be determined, then the position of reference colors and colors to be determined must be indicated to the program by the user, for example by mouse clicks. The position of the sample color circle is inputted into the computer program by a first mouse click in the center of the circle formed by the calibration colors gray levels G1 to G16 (see the position of cursor 13 in FIG. 3). In the exemplary embodiment, the user is further aided by showing at the first mouse click a circle 7 around the cursor 13, which provides a reference point for the size of the circle formed by the calibration colors gray levels G1 to G16 in the recording (see FIG. 3). With a second mouse click in the right contrast circle 4, the distance between the center of the circle formed by the calibration colors gray levels G1 to G16 or the opening 2, respectively, and the center of the contrast circle 4 is transmitted to the computer program. The computer program then also knows the orientation of the calibration chart 1. With the now known distance between the center of the contrast circle and the center of the right contrast circle 4, the software then automatically scales the areas of circles to make them larger or smaller (see scaling arrows 14 in FIG. 4), and the calibration chart 1 is rotated accordingly if the calibration chart 1 was recorded at an angle or upside down.

Is the exemplary method for automatic color determination, the computer program outputs after successful computation the following data (see FIG. 5):
an approximate reproduction of the determined color 8,
the color name 9 from the database,
a color number 10, e.g., RGB for monitors and/or CMYK for printers,
a color category 11, e.g., winter color, mark, associations, etc., and
possible comparison colors 12 from other color systems.

In another exemplary embodiment, software, for example a computer program installed on the server, is provided, whereby the software is configured to enable downloading of calibrated color space coordinates. These color space coordinates allow a user to print the just determined and defined colors himself. To this end, only the data required for a calibrated printout have to be provided to the software, such as for example operating system, graphic card, monitor, printer, employed software (version), color space and/or calibration. Devices or programs not yet supported are immediately included in a database used by the software, thereby continuously updating the database.

The quality of the printout can additionally be improved by correcting the calibration errors of the output devices. This can be achieved by printing in a first step the aforedescribed calibrated color space coordinates. It is then checked, for example by using a color table, if the printed color matches the calibrated color space coordinates. If there is any doubt that the color was printed correctly, the printed color is recorded in a second step together with the calibration chart 1. Based on this recording, the actually printed color is determined by using one of the aforedescribed methods. By using the optionally determined difference between the actually printed color and the color which should have been printed by using the determined calibrated color space coordinates, corrected color values can be determined for the device configuration used for printing, which will then ensure a correct color printout.

This process can be repeated for each print. However, the calibration state of the device combination may preferably be determined based on one or several reference colors for which the printed a colors are compared with the corresponding reference color space coordinates. Based on these results from the comparison, the entire color space can then be transformed device-specific and stored on the server. The color space is then available for a calibrated printout, which ensures that the correct color is printed—assuming that the same device configuration is used—, by correcting the calibration errors of the device configuration using the transformed color space coordinates.

If the employed computer configuration for a calibrated printout is not (yet) supported by the server, then a calibrated color pattern can be automatically printed onto the front side of a postcard during the color determination and after registration and mailed to the user. The backside of the postcard can be configured as the calibration chart 1. This practice would support a wide distribution of the calibration chart 1.

These two options for a calibrated printout can also be used for automatically checking the correct color determination—if the photo was created or uploaded by the user himself—, or for automatically obtaining the true color, if the true color was previously seen only on the display screen in the Internet or on television, and one wants to be certain before making a purchase that the article has the desired color.

The method of the invention can be used in different ways

In a first method of use, a user is provided with the calibration chart 1 as well as with the computer program of the invention for use. This is typically free of charge. The user can then determine the color himself. For carrying out the method, the user only requires an additional computer with standard graphic software and a digital camera or scanner.

In another method of use, the user is only provided with the calibration chart 1, and the color is determined by using a (fee-based) service. The user only has to transmit the digital data of the recordings of sample/object 6 together with the calibration chart 1 to the service provider. This can advantageously be done via the Internet, e.g., via e-mail or in a particularly preferred solution, by a simple upload to a server of the service provider. The service provider determines the color automatically and transmits the results to the user.

In another special embodiment, the computer program of the invention is integrated with an online shopping or auction system. The provider of the online shopping or auction system will typically purchase the color determination as a service and provide this service to his customers, so as to ensure an accurate description of the offered articles.

In the last two variants, the user additionally requires access to a data network; he does not have to own the computer program of the invention, as a standard Internet browser is adequate.

For the operation and/or for supporting the user, the exemplary software provides the following buttons:
[OK] for inserting the determined color into the description of the article, e.g., when using the method with an online shopping or auction system,
[Correction] for performing another color analysis,
[Cancel] for canceling color determination,
[Help] for calling a help function when searching or determining according to categories,
[Compare] for calling a help function when searching for or determining comparison colors,
[Add] for multicolored samples,
[Settings] with link to the system control; in Windows® for example: →Display→Settings→Colors (! True Color, 32-bit!)→Expand→Color Administration→Add→sRGB Color Space Profile; alternatively, the link can also point directly from the [Settings] button to ‘Colors’;
translation of the buttons to correspond to the language of the operating system.

The embodiment of the invention is not limited to the aforedescribed preferred exemplary embodiments. Instead, a number of variants can be envisioned which make use of the system and method of the invention even when using fundamentally different embodiments.

### LIST OF REFERENCE SYMBOLS

1, 1a calibration chart
2 opening for sample color
3 colored squares
4 circle with reference contrast values color reference squares
6 samples/object
7 circle around the cursor
8 reproduction of the determined color
9 color name
10 color number
11 color category
12 comparison colors from other color systems
13 cursor
14 scaling arrows

1-31. (canceled)

32. A method for automatic determination of colors for at least one of verification of colors and ensuring color fastness, the method comprising:
simultaneously recording a color to be determined with at least one reference color;
reading the recorded data;
automatically finding the at least one reference color and the color to be determined by:
comparing a pattern within the stored data; or
visualizing the recorded colors and selecting a position within the recorded data of the at least one reference color and the color to be determined;
comparing the recorded data of at least a portion of the at least one reference color with recorded comparison values of the reference colors to determine a difference value; and
automatically determining the color to be determined by processing at least a portion of the recorded data of the color to be determined and at least a portion of the difference value.

33. The method of claim 32, wherein the stored colors are visualized using at least one of a monitor and a display and wherein the position within the stored data of the at least one reference color and the color to be determined is selected using a computer mouse.

34. The method of claim 32, wherein automatically determining the color to be determined further comprises at least one of forming an average value of the recorded data of the color to be determined and forming an average value of the at least one reference color.

35. The method of claim 32, further comprising reading in a plurality of reference contrast values in addition to the at least one reference color.

36. The method of claim 35, further comprising providing the at least one reference color to be read in and the plurality of reference contrast values on a carrier element.

37. The method of claim 36, further comprising arranging at least one of reference colors and the plurality reference contrast values on the carrier element in a predetermined pattern.

38. The method of claim 36, further comprising:
arranging the at least one reference color, the plurality of reference contrast values and the color to be determined on the carrier element in a pattern as concentric circular rings;
selecting a marked location recorded on the carrier element; and
determining the data associated with the at least one reference color, the plurality of reference contrast values and the color to be determined based on the pattern defined on the carrier element and position data of the selected marked location.

39. The method of claim 36, further comprising:
arranging the at least one reference color and/or the plurality of reference contrast values on the carrier element in a pattern as circular sectors and arranging the color to be determined at a predetermined position;
selecting the center of the circle formed by the circular sectors and selecting the position of the color to be determined; and
determining, based on the pattern and position data defined on the carrier element, the data associated with the at least one reference color, the plurality of reference contrast values and the color to be determined.

40. The method of claim 36, further comprising:
arranging the at least one reference color and/or the plurality of reference contrast values on the carrier element as circular sectors and arranging the at least one color to be determined at a predetermined position;
selecting the center of the circle formed by the circular sectors and selecting the position of the at least one reference color; and
determining, based on the pattern and position data of the selected marked location defined on the carrier element, the data associated with the at least one reference color, the plurality of reference contrast values and the color to be determined.

41. The method of claim 32, further comprising storing the comparison values of the at least one reference color in a database, wherein the database provides color renditions according to at least one color system.

42. The method of claim 32, further comprising:
linking the determined color with additional data and providing the determined color with the additional data.

43. The method of claim 42, wherein the additional data further comprises information about comparable colors of other color catalogues and/or color proposals for combination with the determined color.

44. The method of claim 32, wherein the recorded data is recorded using visualization or graphic software with a color system, a digital camera or a scanner and wherein the recorded data is transmitted over a communications network.

45. The method of claim 32 further comprising automatically correcting corruption of the digital color analysis being caused by the recording or representation of the visualization, graphic or CAD software, after comparison of at least a portion of the reference colors with stored comparison values of the reference colors.

46. A system for at least one of verification of colors and ensuring color fastness, the system comprising:
means for recording colors, wherein the colors are arranged for simultaneously recording at least one color to be determined with at least one reference color in computer-readable form;
at least one data processing device;
means for data input and data output;
means for data storage;
instructions stored in the means for data storage, wherein the instructions are executable to:
read the recorded data;
automatically find data of at least one of the reference colors and the color to be determined by:
comparing a pattern within the recorded data; or
visualizing the recorded colors by means for data output, and feeding the position within the recorded data of at least one of one or several reference colors and color to be determined into the instructions via means for data input;
compare data of at least a portion of the reference colors with stored comparison values of the reference colors;
automatically determine the color to be determined by evaluating at least a portion of the recorded data of the color to be determined and at least a portion of the difference values between the read data and the stored comparison values determined during the comparison.

47. A computer-readable medium comprising executable instructions for automatic determination of colors for at least one of verification of colors and ensuring color fastness, the instructions being executable to:
record simultaneously a color to be determined with at least one reference color in computer-readable form;
read the recorded data;
automatically find at least one of data of the reference colors and the color to be determined by:
comparing a pattern within the recorded data, or
visualizing the recorded colors, and feeding the position within the recorded data of the at least one reference color and the color to be determined into the executable instructions;
compare the recorded data of at least a portion of the at least one reference color with stored comparison values of the reference colors;
automatically determine the color to be determined by evaluating at least a portion of the recorded data of the color to be determined and at least a portion of the difference values between the read in data and the stored data that were determined in the comparison.

48. The computer readable medium of claim 47, wherein the computer readable medium is downloaded over a computer network.

49. A method for automatic determination of colors for at least one of verification of colors and ensuring color fastness, the method comprising:
providing by a provider a carrier element, on which at least one reference color is arranged;
recording a color to be determined together with at least one reference color arranged on the carrier element by a user;
transmitting by the user the recorded data to a provider;
determining by the provider a fee for the color to be determined;
reading the transmitted data;
automatically finding the at least one reference color and the color to be determined by:
comparing a pattern within the recorded data; or
visualizing the recorded colors and storing the position within the recorded data of the at least one reference color and color to be determined;
comparing the recorded data of at least a portion of the at least one reference color with stored comparison values of the reference colors;
automatically determining the color to be determined by evaluating at least a portion of the recorded data of the color to be determined and at least a portion of the difference values between the read in data and the stored comparison values determined in the comparison; and
at least one of transmitting the determined color to the user and providing the determined color for recall.

50. The method of claim 49, wherein the method is performed in connection with a service selected from the group consisting of: online shopping, B2B purchase, online bids or online auction systems, and the option of transmitting the computer-readably generated, imported and/or recorded data to the provider.

51. The method of claim 49, further comprising:
distributing carrier elements by the provider to end customers through the mail or through a company which is independent of the provider;
wherein the method is performed over the Internet from a server of the independent company; and
making available central updating and upgrading facilities or providing single-user licenses for decentralized installation at the licensee having his own server.
